(19) United States
(12) Patent Application Publication
(10) Pub. No.: US 2004/0213233 A1
(43) Pub. Date: Oct. 28, 2004

(54) Method and apparatus for routing in asynchronous transfer mode communication network

(76) Inventors: Won Kyu Hong, Daejeon-shi (KR); Mun Jo Jung, Daejeon-shi (KR)

Correspondence Address: MERCHANT & GOULD P.C., P.O. Box 2903, Minneapolis, MN, 55402-0903, US

(21) Appl. No.: 09/735,393

(22) Filed: Dec. 12, 2000

(30) Foreign Application Priority Data
Sep. 22, 2000 (KR) 2000-55742

(51) Int. Cl. H04L 12/28; H04L 12/56

(52) U.S. Cl. 370/392; 370/401; 370/395.1

(57) ABSTRACT

The present invention relates to a method and apparatus for routing an asynchronous transfer mode communication, and in particular to a method and apparatus for routing an asynchronous transfer mode communication network to satisfy a user's desired service quality by providing a terminal-to-terminal optimum path in a divided hierarchical network structure and maximizing the efficiency of a network resource. The present invention performs BFRA (Bounded Flooding Routing Algorithm) on a network topology information provided by a network management system to form a routing table. The routing entries in the routing table are aligned by the order of total cost assigned to the entries. Finally, the present invention performs a connection allowance control on the routing entries in the routing table to select an optimum path based on a bandwidth required by the network management system.

### BACKGROUND OF THE INVENTION

1. Field of the Invention

The present invention relates to a method and apparatus for routing in an asynchronous transfer mode communication network for providing an optimum path in an ATM (Asynchronous Transfer Mode), and in particular to a method and apparatus for routing an asynchronous transfer mode communication network which provides an optimum routing path for maximizing an efficiency of a network resource in an ATM communication network and an optimum routing path having a best performance for a user.

2. Description of the Background Art

From the perspective of a network service provider, when building a large size ATM communication network, it is important to build a network system using a minimum network resource and provide a service to the maximum number of users. In addition, it could be better if the user can get a best quality service at a minimum cost. Therefore, it is needed to provide various yet distinguished services from other existing services to meet a user's expectations.

For satisfying the above-described conditions and implementing an efficiency of the network management, the network service provider has developed a new system by dividing the entire network into a plurality of local management region networks.

The above network division is called a hierarchical network construction. FIG. 1 is a view illustrating a conventional network division construction in which a network division is implemented based on a management region of a large size network formed of a plurality of ATM switches.

As shown in FIG. 1, the entire network is divided into four partial networks 11, 12, 13 and 14, respectively, and four ATM switches 11-1, 11-2, 11-3 and 11-4, 12-1, . . . , 14-4 are allocated to the individual partial network, so that each of the partial network 11, 12, 13 and 14 manages corresponding ATM switches.

In the conventional partial network structure which implements an easier management of the hierarchical network construction, since only asynchronous

ATM switch in its management region is managed as a destination, in the case that the entire network is expanded by adding an ATM switch to the existing partial network or adding a new partial network, it is not needed to add to the other partial networks or manage the deleted switches. In addition, the hierarchal network construction based on the network division is necessary for the network service provider. The path selected at an ATM switch level will be explained based on the network topology of FIG. 1.

If a link 2 is selected, a third switch 11-3 of a first partial network 11 and a 13th switch 14-1 of a fourth partial network 14 must be passed through. Therefore, the number of the entire switches between the transfer/receiving points is 8 because the first, second, third and fourth switches 11-1, 11-2, 11-3, 11-4 must be passed through in the first partial network 11, and the 13th, 14th, 15th and 16th switches 14-1, 14-2, 14-3, and 14-4 must be passed through in the fourth partial network 14.

In a view of the switch level, on the top level, it is impossible to have a routing path due to the divided network, so that a path is selected using a link information between the partial networks. Therefore, in the conventional ATM network, since it is impossible to consider the network topology inside of the partial network, the optimum path is not selected at the switch level.

In other words, in the conventional network division structure, although the abstracted network topology of the low level partial network makes it possible to ease thee management in terms of the network management, however, in this case, it can not provide the optimum path where terminal-to-terminal is concerned. For the network, the network resource is unnecessarily consumed, and the user is not guaranteed to receive a desired service quality.

### SUMMARY OF THE INVENTION

Accordingly, it is an object of the present invention to provide a method and apparatus for routing an asynchronous transfer mode communication to satisfy a user's desired service quality by providing a terminal-to-terminal optimum path Ad in a divided hierarchical network structure and maximizing an efficiency of a network resource.

To achieve the above object, there is provided a routing method in an ATM for providing an optimum path through a network management system in an ATM (Asynchrornous Transfer Mode) divided into a plurality of partial networks, which includes a first step for forming a main routing table based on an inputted network topology information when the network topology information with respect to the divided partial network is inputted from the network management system which manages an ATM communication network, a second step for forming a sub-routing table based on the changed network topology information in a sub-routing apparatus when the network topology information is inputted from the network management system when the network topology information is changed in the main routing apparatus is initialized, a third step for copying the network topology information of the sub-routing table to the main routing table and updating the network topology information of the main routing table, a fourth step in which when a routing service is requested from the network management system, the main routing apparatus aligns the routing entries designated in the main routing table and allocates a priority, and a fifth step for controlling a connection allowance with respect to each routing entry based on the priority and performing a routing service.

In addition, there is provided a routing apparatus of an ATM communication network for providing an optimum path through a network management system in the ATM (Asynchronous Transfer Mode) communication network divided into a plurality of partial networks, which includes a unit for forming a main routing table based on an inputted network topology information when the network topology information with respect to the divided partial network is inputted from the network management system which manages an ATM communication network, a unit for forming a sub-routing table based on the changed network topology information in a sub-routing apparatus when the network topology information is inputted from the network management system when the network topology information is changed in the main routing apparatus is initialized, and copying the network topology information of the sub-routing table to the main routing table and updating the network topology information of the main routing table, and a unit by which when a routing service is requested from the network management system, the main routing apparatus aligns the routing entries designated in the main routing table and allocates a priority for controlling a connection allowance with respect to each routing entry based on the priority and performing a routing service.

Moreover, there is provided an ATM routing apparatus for providing an optimum path through a network management system in an ATM (Asynchronous Transfer Mode) communication network divided into a plurality of partial networks, which includes a unit for forming and storing a main routing table by adapting a bounded flooding routing algorithm (BFRA) to the network topology information with respect to a divided sub-partial network inputted from a network management system which manages the ATM communication network, a unit for forming a sub-routing table by adapting the bounded flooding routing algorithm (BFRA) to the network topology information with respect to the changed partial network inputted form the network management system, and a unit for providing a service based on the information of the main routing table in response to a request of the network management system and providing a routing service using the sub-routing table in the case that the main routing table is damaged.

### BRIEF DESCRIPTION OF THE DRAWINGS

The present invention will become better understood with reference to the accompanying drawings Which are given only by way of illustration and thus are not limitative of the present invention, wherein;

FIG. 1 is a view illustrating a network divide structure in a conventional ATM (Asynchronous Transfer Mode);

FIG. 2 is a view illustrating the construction of an entire network for explaining a transfer and receiving combination for a routing path computation according to the present invention;

FIG. 3 is a view illustrating a bounded flooding routing algorithm (BFRA) according to the present invention;

FIG. 4A is a routing table which is computable in a hierarchical structure network according to the present invention;

FIG. 4B is a view illustrating an optimum path computed based on a routing table of FIG. 4A;

FIG. 5 is a view illustrating a new network topology information defined by adapting an internal cost and reachability (ICR) in a partial network connection according to the present invention;

FIG. 6 is a routing table formed by adding the internal cost and reachability (ICR) in a partial network according to the present invention;

FIG. 7 is a view illustrating the inner construction of a routing management apparatus which is capable of adapting a routing algorithm according to the present invention;

FIG. 8 is a flow chart of a procedure for building a network topology information based on a network management system when initializing a routing management apparatus of FIG. 7 and a procedure for forming a routing table according to the present invention;

FIG. 9 is a flow chart of a procedure for forming a new routing table based on a routing management apparatus when changing a network topology based on a network management system according to the present invention; and

FIG. 10 is a flow chart of a procedure for providing a routing service for implementing an optimum path based on a routing management apparatus according to the present invention.

### DETAILED DESCRIPTION OF THE PREFERRED EMBODIMENTS

The embodiments of the present invention will be explained with reference to the accompanying drawings.

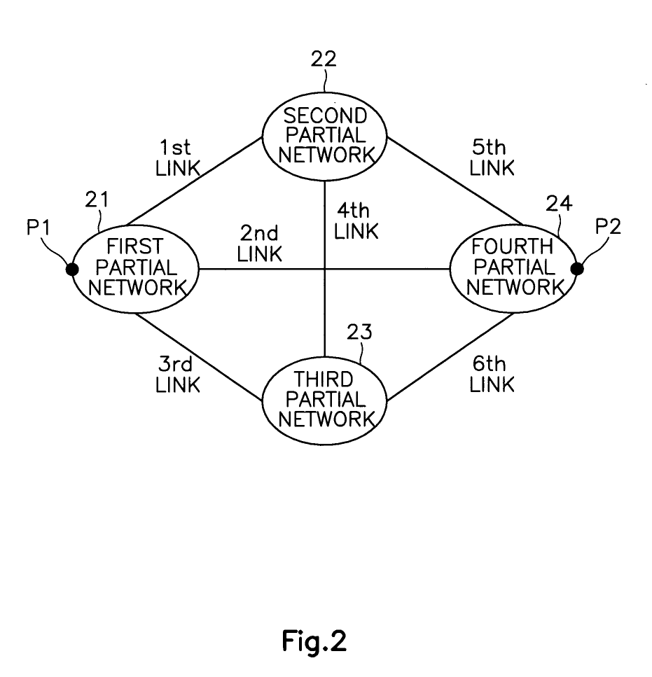

FIG. 2 is a view illustrating the construction of the entire network for explaining a transfer and receiving combination for a routing path computation according to the present invention. As shown therein, a hierarchical structure of the ATM communication network is provided based on better efficiency of network management and expandability of the same for implementing a terminal-to-terminal optimum path wherein there are provided a divided partial network, not a network topology of an ATM switch level, and a link in-between.

Table 1 is a routing table with respect to all combinations between possible partial networks in a network structure as shown in FIG. 2.

TABLE 1

| | | Number |
|---|---|---|
| Transfer/receiving points(P1/P2) | Flooding boundary | of paths |
| 1st partial network(21) <-> 2nd partial | 3 | N |
| network(22) | | |
| 1st partial network(21) <-> 3rd partial | 3 | N |
| network(23) | | |
| 1st partial network(21) <-> 4th partial | 3 | N |
| network(24) | | |
| 2nd partial network(22) <-> 3rd partial | 3 | N |
| network(23) | | |
| 2nd partial network(22) <-> 4th partial | 3 | N |
| network(24) | | |
| 3rd partial network(23) <-> 4th partial | 3 | N |
| network(24) | | |

As shown in FIG. 2 and Table 1, because of four partial networks as shown in FIG. 2, six transfer and receiving point routing table combinations are generated as shown in Table 1. Here, in the case that “n” is the number of the partial networks, the number of the combinations of the transfer/receiving points P1/P2 with respect to the routing table which will be formed is n(n−2)/2.

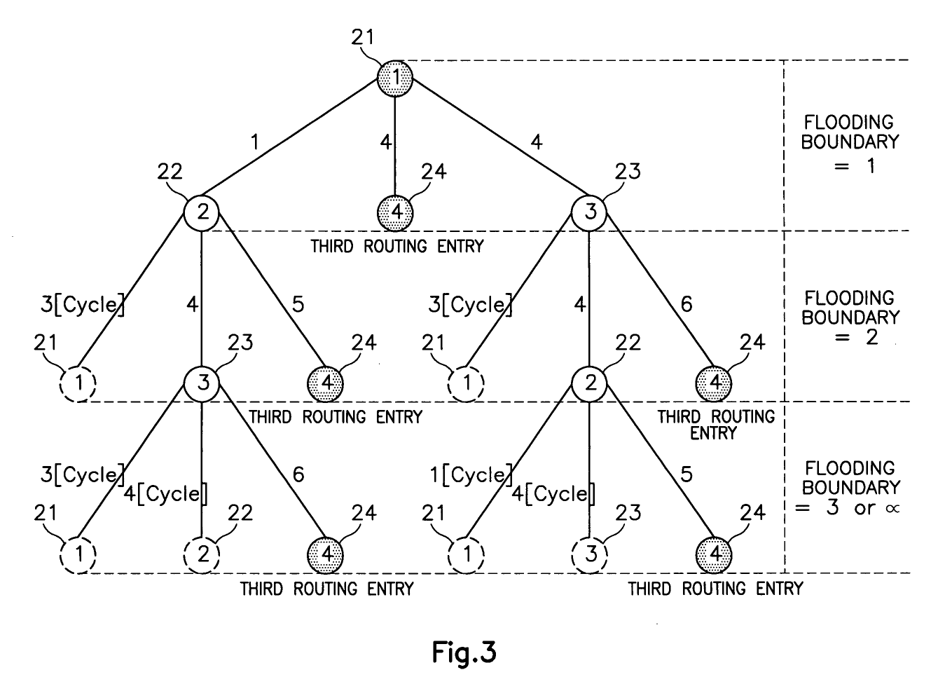

The formation of the routing table is implemented by a bounded flooding routing algorithm (BFRA) as shown in FIG. 3. As shown in FIG. 3, the algorithm in FIG. 3 is an important factor which determines the performance of the routing apparatus. The algorithm in FIG. 3 computes all possible routing entries which exist between the transfer and receiving points and compares with the routing table. At this time, as the network topology gets complicated, and the number of the network links is increased, the time required for forming the routing table is geometrically increased.

Therefore, as shown in FIG. 3, the bounded flooding routing algorithm (BFRA) determines a flooding boundary and does not compute the routing entries which exceed the designated flooding boundary. In addition, in the procedure for computing the routing entry, in the case that the partial network and link which exists in the routing entry is duplicated, the routine is not proceeded, that is, completely stopped. Therefore, it is possible to significantly decrease the time required for forming the routing table.

For example, in the procedure for computing all possible routing entries from the first partial network 21 to the fourth partial network 24, the procedure is proceeded from the first partial network 21 to the second partial network 22 through the link, and the procedure is proceeded from the second partial network 22 to the first partial network through the link 1. In the case that the procedure is proceeded to the first partial network 21 through the link 1 of the second partial network 22 in the procedure in which the flooding boundary=2, it represents the already searched partial network and link, the procedure is not proceeded. Namely, the procedure is proceeded from the second partial network 22 to the third partial network 23 through the link 4. Namely, the partial network indicated by the dotted line among the partial networks of FIG. 3 represents the partial in which the procedure is not proceeded because the duplication occurs in the routing entries.

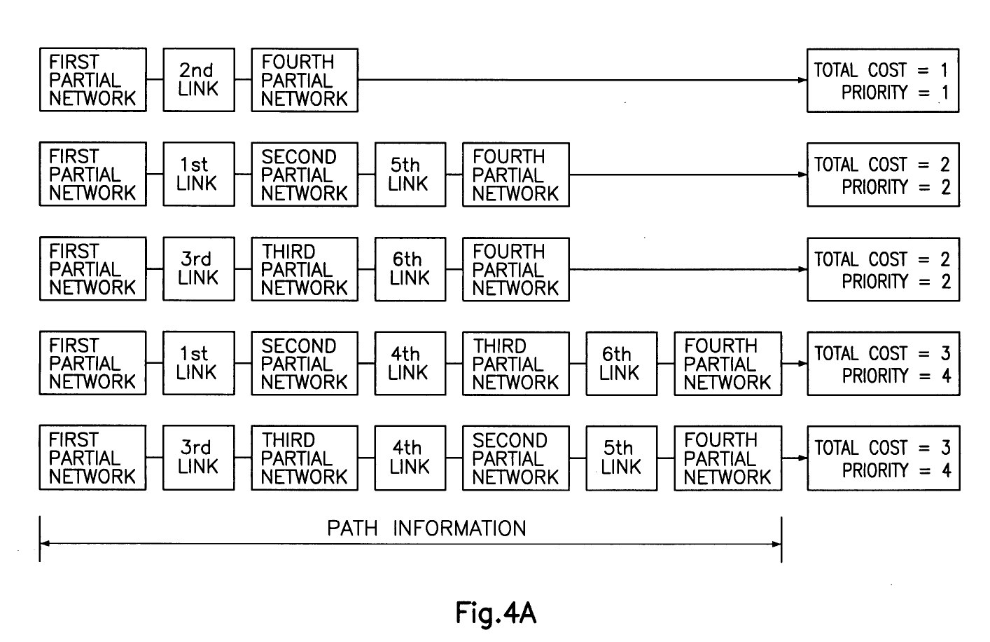

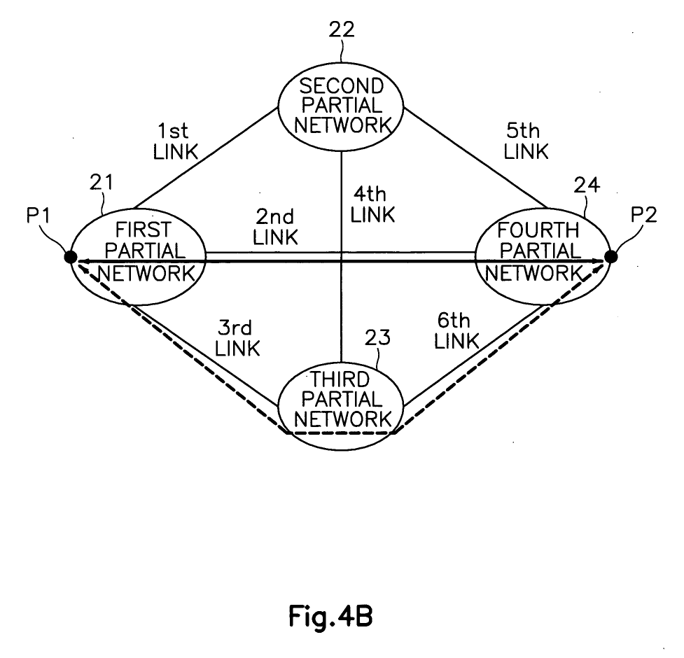

FIG. 4A illustrates a routing table computed between the transfer/receiving points P1/P2 of FIG. 2 by adapting the bounded flooding routing algorithm (BFRA) of FIG. 3 based on the network topology information of FIG. 2. When forming the above routing table, the cost is allocated to the link. At this time, the cost with respect to the link may be randomly determined by an a operator in accordance with a ratio of the remaining bandwidth width. In the present invention, the cost of all links is assumed as “1” for simplification.

In the present invention, as shown in FIG. 4A, in the routing table built by allocating a certain cost to the link between the partial networks, the routing entry in which the optimum path has a priority of 1 is determined as a routing entry. The optimum path is an entry which passes through the first partial network 21, the link 2, and the fourth partial network 24.

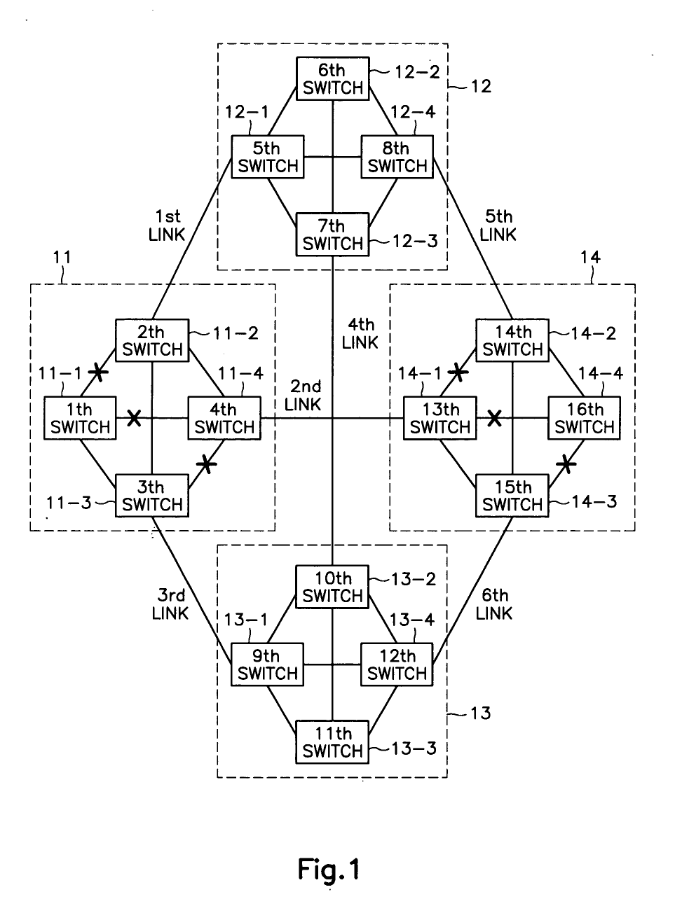

With respect to the network topology of FIG. 1, the above entry passes through the 1st switch 11-1, 2nd switch 11-2, 3rd switch 11-3 and 4th switch 11-4 of the first partial network 11 and the 13th switch 14-1, 14th switch 14-2 and 16th switch 14-4 of the fourth partial network 14 at the switch level. Namely, the entry passes trough totally seven switches.

With respect to the switch level according to the present invention, the above entry passes through the 1st switch 11-1 and 3rd switch 11-2 of the first partial network 11, the 9th switch 13-1 and 12th switch 13-4 of the third partial network 13 and the 15th switch 14-3, the 14th switch 14-2 and the 16th switch 14-4 of the fourth partial network 14. Namely, the entry passes through totally seven switches. FIG. 4B is a view illustrating each optimum path. The path indicated by the dotted line represents an optimum path in a view of the switch level according to the present invention.

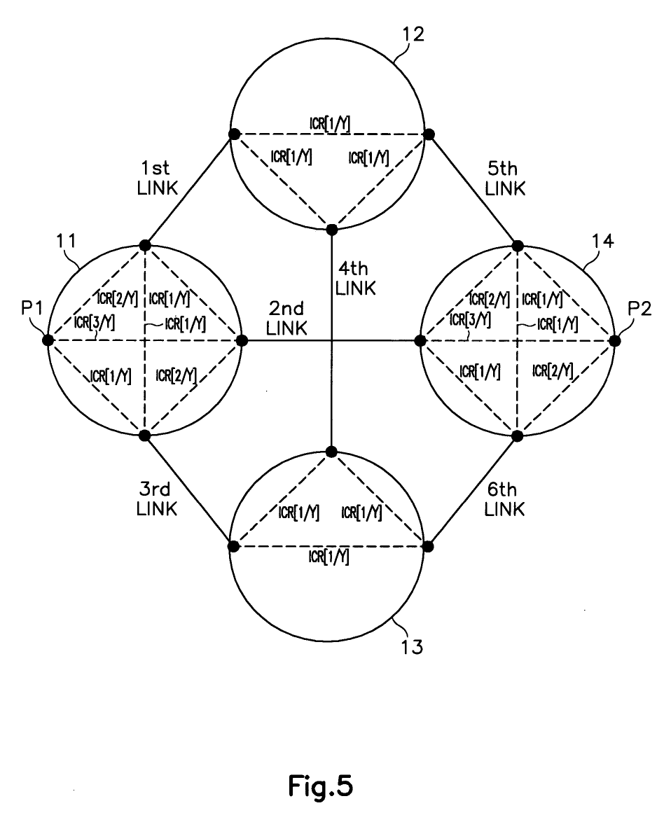

In addition, in the present invention, the internal cost and reachability (ICR) information is additionally defined based on the network topology of the partial network as shown in FIG. 5.

As shown in FIG. 5, the internal cost and reachability (ICR) information of the partial network is defined as a reachability (Yes/No) and cost (number of a switches) between the ATM switches based on the network topology information of the interior of the partial network. Here, the cost allocated to the link between the partial networks when building the routing table as shown in FIG. 4A is allocated based on the ratio with respect to the remaining band width of the link. The cost of the interior of the partial network represents the number of the links of the shortest path which may exist between two switches.

Therefore, a path between the transfer point P1 in the interior of the first partial network 21 and the receiving point P2 which is terminated at the first partial network 21 is computed using the topology of the network of FIG. 1. The shortest path therebetween may be a link which directly connects the first switch 11-1 and the fourth switch 11-4 of the first partial network 21. Since the above described link has an error and is not available (here, in FIG. 1, the link having the mark “x” represents a link having an error), a corresponding path through the 1 st switch 11-1, the 2nd switch 11-2, the 3rd switch 11-3 and the 4th switch 11-4 is formed of three links. Therefore, the internal cost with respect thereto is allocated to “3”, and the reachability is “Yes”.

In the case that there is not a reachable path due to a link error between two switch links, the cost is 0, and the reachability is set to “No”. In this case, the path is eliminated from the selection of the routing path.

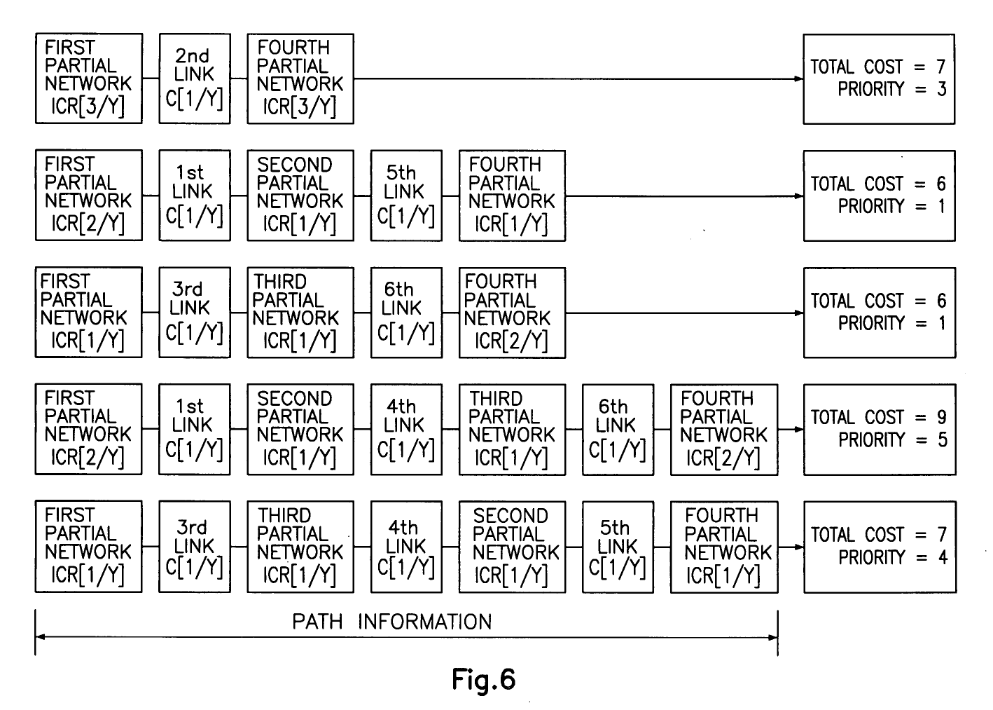

FIG. 6 is a routing table which is formed by adding the cost of the internal partial network and the reachability information for providing a single-to-single optimum path.

As shown in FIGS. 4A and 6, in FIG. 4A, the cost of the internal partial network and the reachability information are not adapted to the routing table. In FIG. 6, the cost of the internal partial network and the reachability information are adapted to the routing table. In FIG. 6, the routing table entry having the priority of 1 in FIG. 4A is changed to the priority of 3 by adapting the cost and the reachability of the internal partial network. Two routing entries having the entire cost of 6 is changed to the priority of 1.

The routing entry of the priority of 1 defined in FIG. 6 is an optimum path which passes through seven switches at the switch level. Therefore, it is possible to provide an optimum routing path in the hierarchical network.

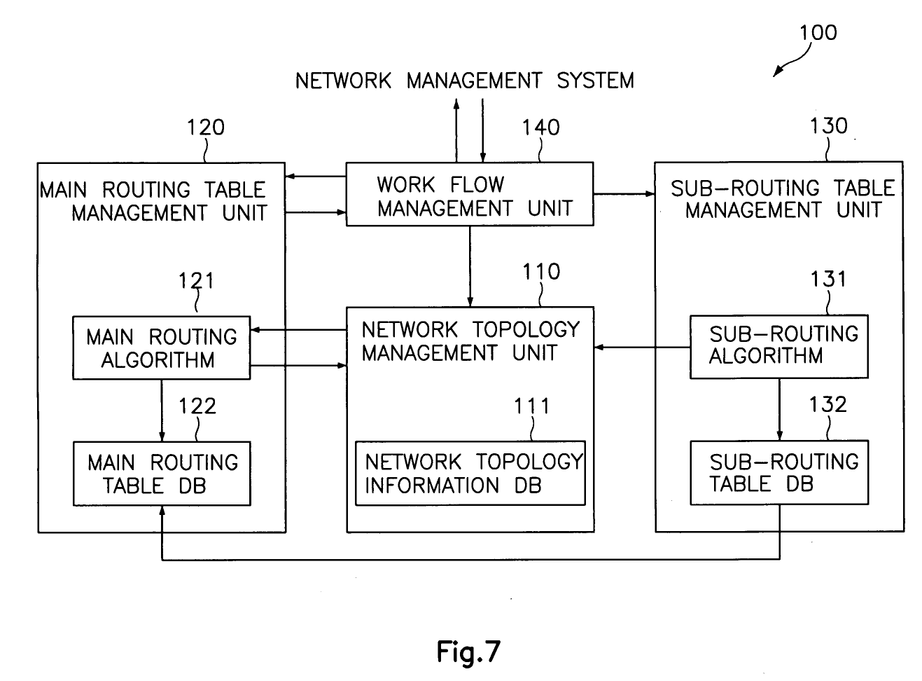

FIG. 7 is a view illustrating an inner construction of the routing management apparatus 100 which is capable of adapting a routing algorithm according to the present invention and includes a network topology management unit 110, a main routing table management unit 120, a sub-routing table management unit 130 and a work flow management unit 140. The main routing table management unit 120 includes a main routing algorithm 121 and a main routing table DB 122. The sub-routing table management unit 130 includes a sub-routing algorithm 131 and a sub-routing table DB 132. Here, each routing algorithm 121, 131 represents a bounded flooding routing algorithm (BFRA). The bounded flooding routing algorithm (BFRA) sets a certain flooding boundary and does not produce the routing entry which exceeds the previously set flooding boundary. Namely, the bounded flooding routing algorithm (BFRA) represents that the operation is stopped with respect to the partial network existing in the routing entry or the link.

As shown in FIG. 7, the network topology management unit 110 receives a network topology information that the network management system provides and stores in the internal network topology information DB 111, and the main routing table management unit 120 includes the internal main routing algorithm 121 and forms a routing table using the bounded flooding routing algorithm (BFRA) based on the network topology information and stores into the main routing table DB 122.

In addition, the sub-routing table management unit 130 includes the internal sub-routing algorithm 131 and forms a routing table using the bounded flooding routing algorithm (BFRA) and stores into the sub-routing table DB 132.

The work flow management unit 140 divides a work request with respect to the routing apparatus to an internal management apparatus (not shown) and requests a routing service to the sub-routing table management unit 130, not the main routing table management unit 120 when the main routing table is damaged.

The routing management apparatus 100 performs different operations based on a routing apparatus initialization, a network topology change and routing service.

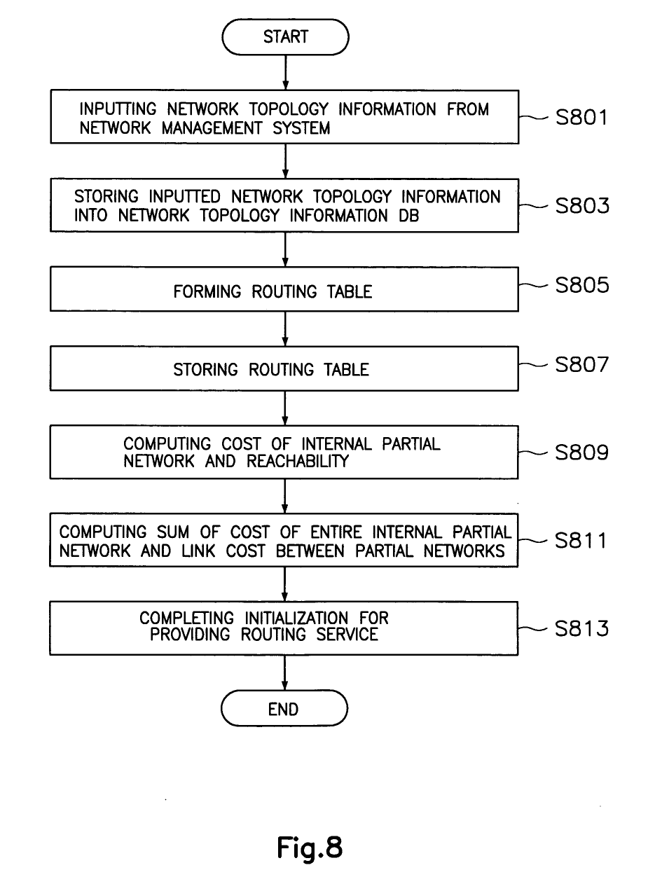

FIG. 8 is a flow chart of a network topology information building procedure based on an inter-work with a network management system when initializing the routing management apparatus 100 of FIG. 7 and a routing table formation procedure based on the built information hereto.

When a network topology information is inputted from a network management system into a work flow management unit 140 of the routing management apparatus 100 (S801), the work flow management unit 140 transfers a network topology information to the network topology management unit 110 and stores into the network topology information DB 111 (S803).

In addition, the work distribution apparatus (not shown) of the routing management apparatus 100 requests to build a routing table using the information of the network topology information DB 111 using the bounded flooding routing algorithm (BFRA) of the main routing table management unit 120, namely, the main routing algorithm 121, and the main routing table management unit 120 builds the routing table in response thereto (S805).

The main routing table management unit 120 stores the built routing table into the main routing table DB 122 (S807) and computes the cost of the internal partial network and the reachability of the network topology information DB 111 and allocates the cost to the link between the partial networks based on the remaining bandwidth ratio (S809).

At this time, when a cost allocation is completed with respect to the link of the cost and reachability of the internal partial network, the cost of the internal partial network and the cost of the link of the partial network is summed with respect to all routing entries which exist in the main routing table 122 (S811), and the summed value is stored into the main routing table 122 for thereby completing an initialization operation, so that the routing service is provided (S813).

When the network topology is changed (switch addition/deletion, line addition/deletion, partial network addition/deletion) in a process in which the routing service is provided based on the main routing table maintained by the main routing table management unit 120, the existing routing table must be reconstructed. At this time, it takes a few seconds or a few minutes for the routing table re-construction. Therefore, it is impossible to provide the routing service during the reconstruction time.

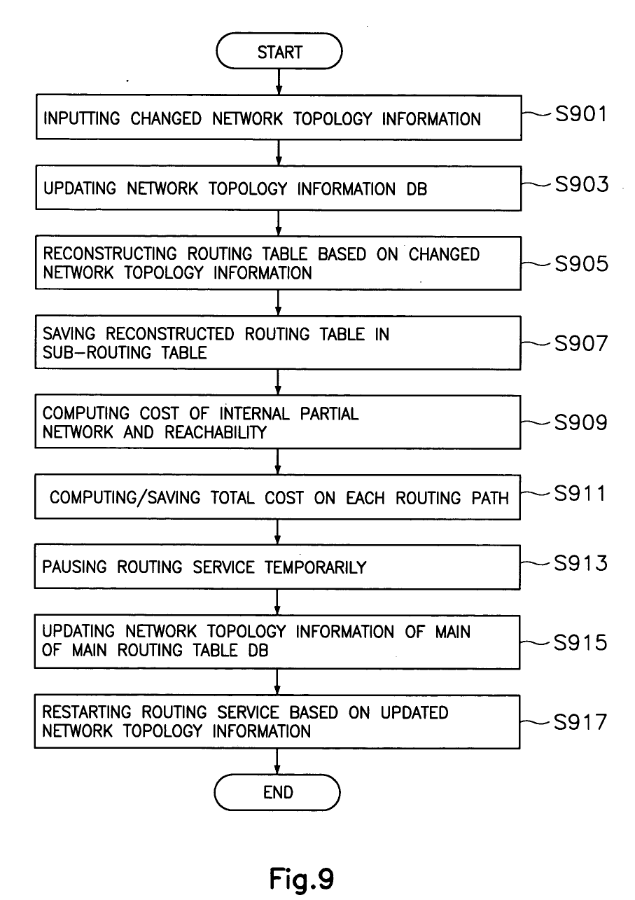

FIG. 9 is a flow chart of a procedure for forming a new routing table based on a routing management apparatus 100 when changing a network topology by a network management system according to the present invention.

As shown therein, in the network management system, when the network topology is changed, a state that the network topology information is changed is reported to the routing management apparatus 100. When a state that the network topology information is changed is inputted from the network management system into the routing management apparatus 100 (S901), the network topology management unit 110 updates the network topology information DB 111 based on the inputted information.

The work flow management unit 140 recognizes that a routing reconstruction is needed based on the network topology change and requests a routing table reconstruction to the sub-routing table management unit 130, and the sub-routing table management unit 130 forms a new routing table based on the changed network topology information using the sub-routing algorithm 131, namely, the bounded flooding routing algorithm (BFRA) (S905).

The sub-routing table management unit 130 stores the reconstructed routing table into the sub-routing table DB 132 (S907) and computes the cost and reachability of the internal partial network in accordance with the network topology information of the internal partial network which exists in the network topology information database 111 and allocates a cost to the link between the partial networks based on the remaining bandwidth ratio of the link (S909).

When the cost allocation with respect to the cost and reachability of the internal partial network and the link between the partial networks is completed, the sub-routing table management unit 130 computes the sum of the cost of the internal partial network and the cost of the link between the partial networks with respect to all routing entries which exist in the routing table, and the summed value is stored into the sub-routing table DB 132 (S911).

The work flow management unit 140 temporarily stops a routing service (S913) and deletes the contents of the main routing table DB 122 and copies the content stored in the sub-routing table DB 132 to the main routing table DB 122 (S915). Therefore, a new routing table which is reconstructed based on the changed network topology is stored into the main routing table DB 122.

When the network topology information stored in the main routing table DB 122 is updated, the work flow management unit 140 restarts the stopped routing service, so that a routing service is provided based on the changed network topology information (S917).

The reason that the main routing management unit 120 and the sub-routing management unit 130 are used in the present invention will be explained. The damage of the routing table maintained by the routing management apparatus 100 represents the stop of a service of the connection through the communication network, so that a critical problem occurs in the system. In order to overcome the above problem, in the present invention, in the vase that the main routing table DB 122 is damaged, the sub-routing table DB 132 is connected for thereby providing the service. While the above-described operation is being performed, the main routing table DB 122 is reconstructed by the main routing table management unit 120. Therefore, in the present invention, it is possible to provide a continuous communication network connection service without stops.

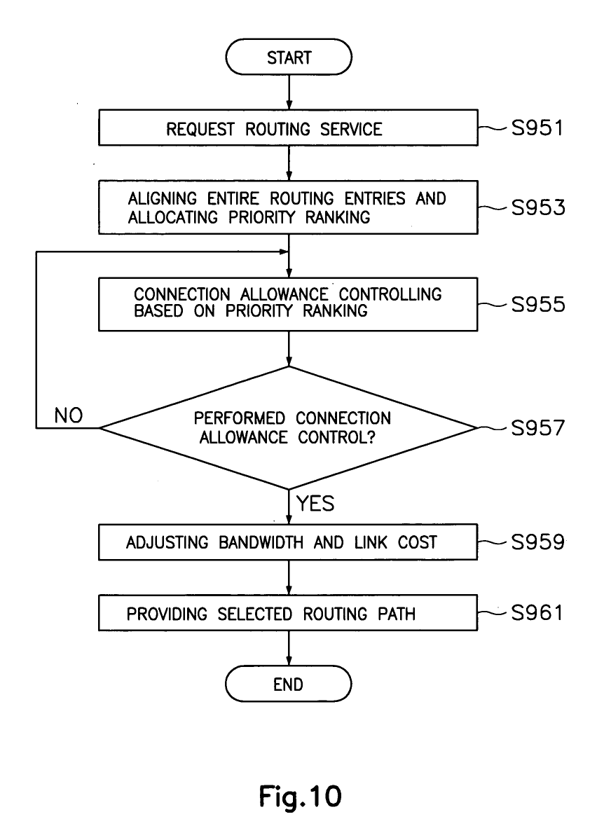

FIG. 10 is a flow chart of a procedure for providing a routing service for providing an optimum path based on the routing management apparatus 100 according to the present invention. The above procedure will be explained with reference to FIG. 10.

A bandwidth which will be allocated to a connection with the transfer and receiving terminal points that the network management system will connect is designated, and a routing service is requested to the routing management apparatus 100 (S951). The routing management apparatus 100 which received the routing service request requests a routing path to the main routing table management unit 120 and the sub-routing management unit 130 based on the state of the current main routing table DB 122 and the sub-routing table DB 132 by the work flow management unit 140. At this time, the main routing table DB 122 has a priority higher than the sub-routing table DB 132. If the main routing table DB 122 is abnormal or is being reconstructed, a new routing path is requested to the sub-routing table management unit 130.

The main/sub routing management units 120 and 130 which received the routing path request align the routing entries with respect to the transfer/receiving points designated in the routing table DB 122 and 132 in a sequence that the sum of the entire costs is smaller, and the priority is stored in the main routing table (S953).

In addition, the main routing table management unit 120 performs a sequential connection allowance control in a sequence that the priority is higher. If the currently selected routing entry does not have a connection allowance control, the routing entry of the next sequence is selected from the main routing table DB 121 for thereby controlling the connection allowance. Here, in the connection allowance control procedure, it is judged whether a corresponding routing entry provides a bandwidth requested by a user of the ATM communication network.

The connection allowance control is repeatedly performed with respect to the routing entry until the routing entry which passes through the connection allowance control is detected from the routing entries having the top priorities. If a certain routing entry passes through the connection allowance control (S957), the network topology management unit 110 searches a link between the partial networks through which the selected routing entry passes, and the bandwidth of the link is decreased by the bandwidth which will be allocated to the connection (S959). In addition, since the cost with respect to the link between the partial networks is allocated based on the ratio of the remaining bandwidth, the bandwidth change of the link in the network topology information causes a cost change of the link, so that the total cost and priority of the routing entry existing in the routing table are changed.

When the connection allowance control, namely, the bandwidth information change of the network topology link and the cost change of the routing entry is completed, the main routing table management unit 120 provides a selected routing entry to the network management system for thereby implementing one routing connection service (S961).

As described above, in the present invention, it is possible to provide a terminal-to-terminal optimum path in a large size asynchronous transfer mode network which is hierarchically constructed based on a network management easiness and expandability, and it is possible to form a routing table quickly by mounting the bounded flooding routing algorithm (BFRA). Furthermore, it is possible to continuously provide a routing service using other routing table management apparatus when one routing table management apparatus is damaged by providing multiple routing table management apparatuses. In addition, the sub-routing table management unit performs a routing table reconstruction based on the network topology change, and the routing table reconstruction is completed and is copied to the main routing table. In this method, it is possible to minimize the time required to copy to the routing table compared to the routing service stop time required for the network topology change. In the present invention, in a view of the network service provider, it is possible to set the connection requested by the user using a minimum network resource and to maximize the efficiency of the network resource, so that it is possible to provide the service to the maximum number of the subscribers using the same network resource as the conventional art for thereby increasing the business performance of the network service provider.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a routing method for providing an optimum path through a network management system in an ATM (Asynchronous Transfer Mode) network including a plurality of partial networks, the routine method in the ATM comprising:
a first step for forming a main routing table in a main routing apparatus based on network topology information about the plurality of partial networks which is inputted from the network management system which manages the ATM communication network;
a second step for forming a sub-routing table in a sub-routing apparatus when the network topology information is changed and
the changed network topology information is inputted from the network management system;
a third step for updating the network topology information of the main routing table by copying the network topology information of the sub-routine table to the main routing table;
a fourth step for making the main routing apparatus align the routing entries in the main routing table according to priorities designated to the routing entries when the network management system requests routine service; and
a fifth step for controlling a connection allowance with respect to each routing entry based on the priority and for performing the routing service.

2. The method of claim 1, wherein said first step includes:
a 11^{th} step for forming a network topology information based on topology information of the partial networks which is inputted from the network management system;
a 12^{th} step for forming the main routing table in the main routine apparatus by applying a bounded flooding routing algorithm (BFRA) to the network topology information;
a 13^{th} step for computing internal cost and reachability in the every partial network and for assigning cost to a link connecting two partial networks according to residual bandwidth of the link; and
a 14^{th} step for computing total cost for every routine entry by adding internal costs of the partial networks and costs of links included in the corresponding routing entry and for assigning the total cost for the corresponding routing entry.

3. The method of claim 1, wherein said second step includes:
a 2^{st} step for forming a sub-routing table in the sub-routing apparatus by applying a bounded flooding routing algorithm (BFRA) to the changed network topology information inputted from the network management system;
a 22^{nd} step for computing internal allocating a link cost and reachability in the every partial network and for assigning cost to a link connecting two partial networks according to residual bandwidth of the link; and
a 23^{rd} step for computing total cost for every routing entry in the sub-routine table by adding internal costs of the partial networks and costs of links included in the corresponding routing entry and for assigning the total cost for the corresponding routine entry.

4. The method of claim 1, wherein said third step includes:
a 31^{st} step for temporarily stopping the routing service;
a 32^{nd} step for copying the network topology information of the sub-routing table to the main routing table and updating the network topology information of the main routing tablet; and
a 33^{rd} step for restarting the routing service.

5. The method of claim 1, wherein said fourth step includes:
a 41^{st} step for computing the total cost with respect to for each of all routing entries to having transfer/receiving terminals designated by the network management system; and
a 42^{nd} step for aligning the routing entries such that higher priority is assigned to a routing entry that has higher total cost.

6. The method of claim 1, wherein said fifth step includes:
a 51^{st} step for performing a connection allowance control with respect to each routing entry in the order of the priorities to check connections with respect to the routine entries are allowed;
a 52^{nd} step for modifying a bandwidth and cost of a link which is included in a routing entry and whose corresponding connection is allowed; and
a 53^{rd} step for supplying the network management system with the modified routine entries and for performing the routing service.

7. The method of claim 1, further comprises:
a step for checking the main routing table; and
a step for overriding the main routing apparatus and the main routing table with the sub-routing apparatus and the sub-routing table respectively in the fourth step when the main routing table cannot be used to provide the routing service.

8. The method of claim 2, wherein said bounded flooding routing algorithm (BFRA) does not output a routing entry which exceeds a flooding boundary and stops an operation with respect to a partial network or link which exists in the exceeded routing entry.

9. The method of claim 4, wherein a update of said network topology information is changed by a switch addition or deletion, a link addition or deletion, ad or a partial network addition or deletion in the ATM communication network.

10. In a routing apparatus for providing an optimum path through a network management system in an ATM (Asynchronous Transfer Mode) communication network including divided into a plurality of partial networks, the routing apparatus of the ATM communication network, comprising:
means for forming a main routing table based on network topology information of partial networks, wherein the a network topology information is inputted from the network management system which manages the ATM communication network;
means for forming a sub-routing table based on the changed network topology information in a sub-routing apparatus wherein the changed network topology information is inputted from the network management system when the network topology information is after the initialization of the main routine apparatus, and for copying the network topology information of the sub-routing table to the main routing table and for updating the network topology information of the main routing table; and
means for making the main routing apparatus align the routing entries in the main routing table according to priorities designated to the routing entries when the network management system requests routine service, and for controlling a connection allowance with respect to each routing entry based on the priorities and for performing the routing service.

11. The apparatus of claim 10, wherein said means for performing the routing service make the sub-routing apparatus align the routing entries according to the priorities designated to the sub-routing entries if the main routine table cannot be used to provide the routing service when the network management system requests the routing service.

12. In a routing apparatus for providing an optimum path by a network management system in an ATM (Asynchronous Transfer Mode) communication network divided into including a plurality of partial networks, the routing apparatus, comprising:
means for forming and storing a main routing table by applying bounded flooding routing algorithm (BFRA) to a network topology information of the plurality of sub-networks inputted from the network management system;
means for forming and storing a sub-routing table by applying the bounded flooding routing algorithm (BFRA) to a network topology information of the plurality of sub-networks inputted from the network management system; and
means for providing a routine service when the network management system requests the routing service, wherein the routing service is based on information of the main routine table if the main routing table is not damaged or the routing service is based on information of the sub-routing table if the main routine table is damaged based on an information of the main routing table in response to a request of the network management system and providing a routing service using the sub-routing table in the case that the main routing table is damaged.
